(19) United States
(12) Patent Application Publication
(10) Pub. No.: US 2025/0053981 A1
(43) Pub. Date: Feb. 13, 2025

(54) Electronic Devices and Corresponding Methods for Delivering Fraud Warnings to an Electronic Device User Interface

(71) Applicant: Motorola Mobility LLC, Chicago, IL (US)

(72) Inventors: Bhavana Bhat, Karnataka (IN); Hariprasad Shanbhogue Alampady, Karnataka (IN); Amit Kumar Agrawal, Bangalore (IN)

(21) Appl. No.: 18/231,528

(22) Filed: Aug. 8, 2023

(51) Int. Cl. G06Q 20/40; G06Q 20/10

(52) U.S. Cl. CPC G06Q 20/4016; G06Q 20/10

(57) ABSTRACT

An electronic device includes a communication device and one or more processors operable with the communication device. When the communication device receives a financial transaction initiation communication from at least one remote electronic device having an electronic device identifier from which a financial transaction initiation request was received by the remote electronic device, the one or more processors determine whether the electronic device identifier is associated with an account identifier of an account used for fraud. When the electronic device identifier is associated with the account identifier of an account used for fraud, the one or more processors cause the communication device to present a prompt on the remote electronic device warning of fraudulent activity.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, scammers and other miscreants have begun to try and exploit security gaps in either the financial applications of the device or user behavior to commit crimes and steal money. It would be advantageous to have improved devices and systems to prevent situations such as this from occurring.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more method steps in accordance with one or more embodiments of the disclosure.

FIG. 2 illustrates one explanatory electronic device in accordance with one or more embodiments of the disclosure.

FIG. 3 illustrates one explanatory server complex in accordance with one or more embodiments of the disclosure.

FIG. 4 illustrates one or more method steps in accordance with one or more embodiments of the disclosure.

FIG. 5 illustrates one explanatory method in accordance with one or more embodiments of the disclosure.

FIG. 6 illustrates one explanatory signal flow diagram in accordance with one or more embodiments of the disclosure.

FIG. 7 illustrates one or more embodiments of the disclosure.

FIG. 8 illustrates a prior art method of getting scammed.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting the initiation of a financial transaction across a network to an account having an account identifier, querying the account identifier to determine if the account is associated with fraudulent activity, and, if the account is associated with the fraudulent activity, transmitting a fraud warning to the remote electronic device prior to the financial transaction being completed. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of receiving a financial transaction initiation communication from at least one remote electronic device comprising an electronic device identifier from which a financial transaction initiation request was received by the at least one remote electronic device, determining whether the electronic device identifier is associated with an account identifier of an account used for fraud, and, if so, presenting a prompt at a user interface warning of fraudulent activity as described herein. The non-processor circuits may include, but are not limited to, a radio receiver, a radio transmitter, signal drivers, clock circuits, power source circuits, and user input devices. As such, these functions may be interpreted as steps of a method to perform receiving a financial transaction initiation communication comprising an electronic device identifier from which a financial transaction initiation request was received, querying a functional database to determine whether the electronic device identifier is associated with fraud, and, if so, presenting a prompt warning of fraudulent activity.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods, electronic devices, and systems that warn users of fraudulent activity before financial transactions are completed. In one or more embodiments, a communication device of an electronic device in communication with at least one remote electronic device detects initiation of an electronic financial transaction across a network to an account having an account identifier. One or more processors of the electronic device then query the account identifier to determine if the account is associated with fraudulent activity. In one or more embodiments, if the account is associated with the fraudulent activity, the one or more processors cause the communication device to transmit a fraud warning to the remote electronic device before the financial transaction is completed.

Advantageously, embodiments of the disclosure alert a potential fraud victim that the destination account to which the financial transaction was directed (and in many cases to which the potential fraud victim was instructed to transfer money) is associated with fraudulent activity before the transfer can be completed. This allows the potential fraud victim to avoid becoming an actual fraud victim.

Embodiments of the disclosure contemplate that many modem electronic devices include both financial applications and shopping applications. Illustrating by example, Motorola Mobility has launched a banking application called DIMO.sup.™ in Brazil. This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.™ are leading to users simply ceasing to carry paper currency or coins. Moreover, applications like DIMO.sup.™ have caused people to stop carrying physical credit and debit cards as well since the credit and debit card account information can simply be loaded into a smartphone, with near-field and other communication devices allowing direct transactions of money electronically.

Embodiments of the disclosure also contemplate that ensuring that such financial applications are fully fraud proof has been challenging in the past. This is true even for well-established financial technology firms. While many additional features and mechanisms have been added to financial applications, examples of which include multi-factor authentication, encryption, and the like, miscreants are still able to make fraudulent transactions. Such transactions seem to be in the news every day.

In many situations, users of financial applications become victims when fraudsters make lucrative offers in phone calls. However, such users can become victims in other ways as well. They may download unsecure applications, visit fraudulent websites, or take other actions where they believe to be acting safely and are instead walking right into the trap of a nefarious actor. In some situations, victims are made to believe that a caller or messenger is legitimate, only to find that they are really crooks when a financial transaction initiated by the victim is directed to a fraudulent account.

Embodiments of the disclosure provide a solution to this madness by providing contextually relevant alerts when a potentially fraudulent transaction is occurring. Advantageously, embodiments of the disclosure help to prevent potential victims from becoming actual victims by preventing them from falling into traps laid by fraudsters.

In one or more embodiments, a functional database is constructed by compiling at least a first set of electronic device identifiers associated with falsified account or personal identification numbers, a second set of electronic device identifiers having associated therewith reports of fraudulent activity exceeding a predefined report threshold, and a third set of electronic device identifiers verified as being associated with fraud by a third party.

In one or more embodiments, a communication device of an electronic device receives a financial transaction initiation communication from at least one remote electronic device in communication with the communication device. In one or more embodiments, the financial initiation communication comprises an electronic device identifier from which a financial transaction initiation request was received by the at least one remote electronic device.

In one or more embodiments, one or more processors of the electronic device then query, in response to the financial transaction initiation communication, the functional database to determine whether the electronic device identifier is found in the first set of electronic device identifiers, the second set of electronic device identifiers, or the third set of electronic device identifiers. In one or more embodiments, when the electronic device identifier is found in the first set of electronic device identifiers, the second set of electronic device identifiers, or the third set of electronic device identifiers, the one or more processors of the electronic device cause the communication device to present a prompt on the at least one remote electronic device warning of fraudulent activity.

Advantageously, embodiments of the disclosure prevent fraudulent activity from being completed in the commission of a crime. Consider some examples:

Imagine a person named John receives a call from the phone of his friend, Peter. Imagine that the person who is talking at the remote end says he's Peter's brother. The speaker then discloses that Peter was in an accident and was admitted to the intensive care unit. The speaker says that Peter needs money urgently to help with medical costs.

Now imagine the speaker sends John a phone number associated with what is alleged to be “Peter's brother's account” and demands money be sent to this phone number. Believing the speaker to actually be Peter's brother, John transfers some emergency funds to the phone number via an electronic banking application. Later, John realizes that this whole charade was nothing more than a fraud played by someone who stole Peter's phone on the subway.

Embodiments of the disclosure prevent such a situation from occurring. In one or more embodiments, an electronic device (such as the one that John would be using if he were smarter) configured in accordance with embodiments of the disclosure includes a communication device and one or more processors operable with the communication device. In one or more embodiments, when the communication device detects initiation of an electronic financial transaction across a network to an account having an account identifier (one example of which is the phone number in the example above), the one or more processors of the electronic device query the account identifier to determine if the account is associated with fraudulent activity. If the acct is indeed associated with the fraudulent activity, in one or more embodiments the one or more processors cause the presentation of a fraud warning at a user interface of the electronic device. Advantageously, this allows the potential victim to terminate the financial transaction before the fraudulent activity is completed.

Consider another example: A person named Clara has a regular habit of buying new, fashionable, designer clothing from fairly new, online shopping sites. One day, when searching for a new clothing design to purchase for her birthday, she finds an exciting “all new” clothing shopping site. She likes it so much she places an order. She completes the order via an online payment to the account identified by the shopping site. Later she realizes that the account was created by fraudsters and the online store was shut down after so many customers complained about becoming fraud victims. Sadly, by this time the damage is done.

Embodiments of the disclosure provide a solution that would prevent Clara from losing her money. In one or more embodiments, a server complex configured in accordance with one or more embodiments of the disclosure is electronically in communication with an electronic device such as the one Clara was using to complete her purchase. In one or more embodiments, a functional database is constructed at the server complex that includes at least a first set of electronic device identifiers associated with falsified account or personal identification numbers, a second set of electronic device identifiers having associated therewith reports of fraudulent activity exceeding a predefined report threshold, and a third set of electronic device identifiers verified as being associated with fraud by a third party.

In one or more embodiments, when Clara attempts to make her purchase, a communication device of the server complex in communication with Clara's electronic device receives a financial transaction initiation communication (her attempted purchase) comprising an electronic device identifier (the website address) from which a financial transaction initiation request was received by Clara's device. In one or more embodiments, one or more processors of the server complex query, in response to the financial transaction initiation communication, the functional database to determine whether the electronic device identifier is found in the first set of identifiers, the second set of identifiers, or the third set of identifiers. If it is found in any of the three, the one or more processors of the server complex cause the communication device to present a prompt on Clara's device warning of fraudulent activity. This would let her stop the transaction before losing her hard-earned do-re-mi.

Consider yet another example: A person named Sandy regularly orders items from online stores. Since she is aware that nefarious actors are everywhere, rather than using a credit card online she prefers to use a “payment on delivery” method at all times. This allows her to pay for a purchase only after it is delivered.

One day, a courier shows up at Sandy's house. The courier has a package and alerts Sandy to the fact that the regular, digital link to complete the payment on delivery payment is not working due to a server issue. For this reason, the courier asks Sandy to make payment to a different account.

Since Sandy has always had success with “payment on delivery,” she trusts the courier and makes a payment to the alternate account. (Oh, Sandy! How could you!) Later on, Sandy realizes she was duped and the package was nothing she ordered, but instead a stack of partially torn, moldy, and soiled TV Guide magazines from 1957. The fraudster faked the parcel with legitimate looking sender/recipient information so well that Sandy believed the parcel to be something she genuinely ordered earlier that week.

Advantageously, embodiments of the disclosure can save Sandy from this perilous outcome. In one or more embodiments, an electronic device is configured as a server complex and comprises a communication device and one or more processors operable with the communication device. In one or more embodiments, when the communication device receives a financial transaction initiation communication from Sandy's device from which a financial transaction initiation request was received by her device, the one or more processors determine whether the electronic device identifier is associated with an account identifier of an account used for fraud. When the electronic device identifier is associated with the account identifier of the account used for fraud, in one or more embodiments the one or more processors cause the communication device to present a prompt on Sandy's device warning of fraudulent activity. This would have allowed Sandy to stop her transfer of her hard-earned cabbage to the fraudster.

In one or more embodiments, an electronic device determines that an account is associated with possible fraudulent activity using a method that compares an account to a functional database including one or more of: phone numbers that are marked as “spam” or marked as “junk” by all mobile users receiving incoming calls from an unknown number. Such spam or junk or fraud phone numbers can be identified in one or more embodiments by authorized third-party service providers, examples of which include TrueCaller.sup.™, WhatsApp.sup.™, GoogleCaller.sup.™, and others.

In one or more embodiments, the functional database can also include phone numbers associated with fake Social Security numbers or Primary Account Numbers from authorized government agencies. In one or more embodiments, the functional database also includes phone numbers of criminals determined from authorized government agencies, examples of which include police databases and court databases.

In one or more embodiments, the electronic device categorizes an account as being associated with fraudulent activity based upon reports by verified users with fraudster bank account details after the verified users made a transaction to a fraudster account by getting duped. In one or more embodiments, such reports are considered verified when a threshold number of such reports are received.

In one or more embodiments, the electronic device provides a timely alert to a user to prevent a financial transaction associated with fraudulent activity from being completed as follows: When a user is about to make a payment, the electronic device can check to see whether the payee account is considered to be associated with fraudulent activity using the functional database described above. In response to detecting that an account is associated with fraudulent activity, the electronic device can alert users about a possible fraud with the warning level being based upon a probability ranking that the fraudulent activity is legitimate. In one or more embodiments, the electronic device can provide more information about the fraudster from the information found in the functional database. In one or more embodiments, the electronic device can provide options that allow the potential victim to block or terminate the financial transaction to the account associated with the fraudulent activity.

Other advantages offered by embodiments of the disclosure will be described below. Still others will be obvious to those of ordinary skill in the art having the benefit of this disclosure.

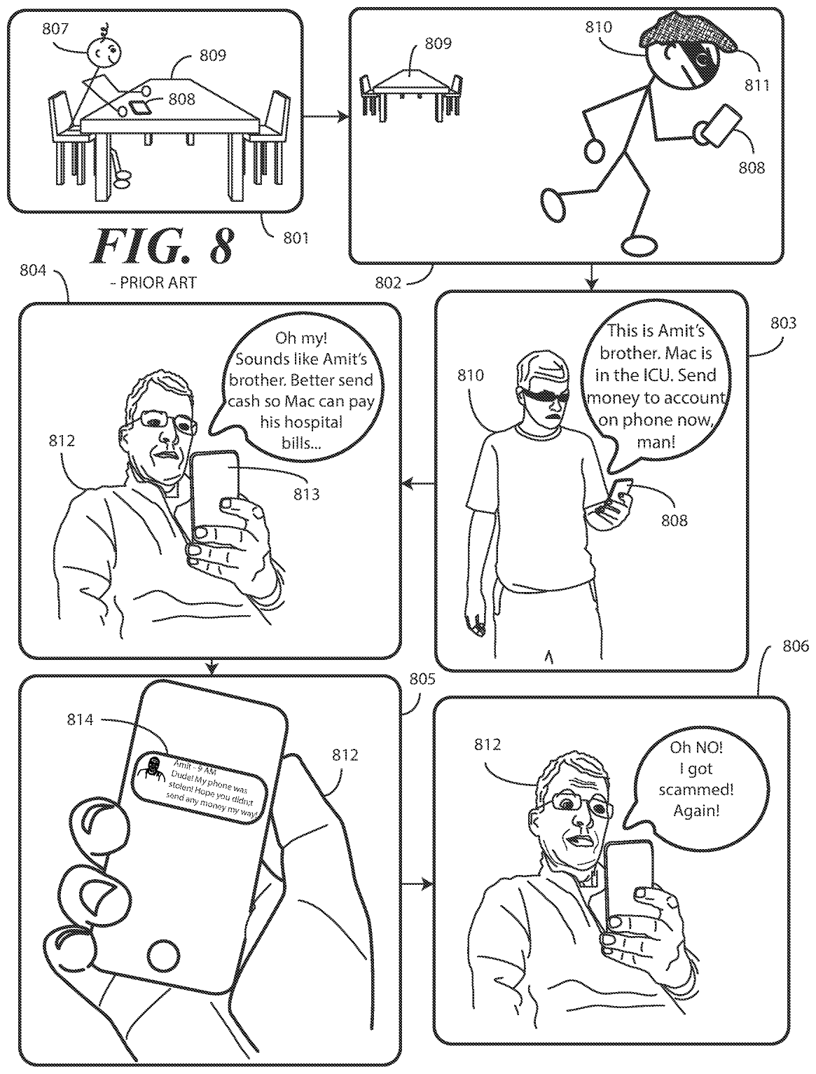

Turning first to FIG. 8, illustrated therein are one or more method steps illustrating how fraud can occur in prior art systems, using prior art devices and methods. Beginning at step 801, Amit 807 is sitting at a café waiting for a medium caramel macchiato in a large cup, but with milk split into thirds with the first third being oat milk, the second third being almond milk, and the third being soy milk, with the caramel drizzled around the sides of the cup before the milk and with double vanilla syrup, with extra ice, three shots of espresso, cinnamon, a pump of hazelnut, whipped cream, and a white mocha floater and curls. Unfortunately, while reviewing this relatively complicated order in his head to ensure that no ingredients were missed, he zones out for a minute and forgets that his smartphone 808 is on the table 809 and not in his pocket.

Amit finally hears his name being called. Almost drooling at the thought of his caramel macchiato in a cup large enough to safely hold all the accoutrements, he runs to the counter to see the barista while leaving his smartphone 808 on the table 809. Unfortunately, a fraudster 810 observes Amit's careless act of beverage-induced tunnel vision and snatches the smartphone from the table 809 at step 802.

At step 803, the fraudster 810, having lost the terrible hat 811 (shown at step 802), starts scrolling through Amit's smartphone 808 to look through contacts and finds a frequently called friend named Buster 812, who is shown at step 804. The fraudster 810 knows that the best scams occur when they involve someone somewhat known to the potential mark as an alleged victim and someone tangentially related to an acquaintance of the mark. The fraudster 810 knows that if a complete stranger called Buster 812 and asked for money, Buster 812 may be savvy enough to question the veracity of the request. However, is someone calls Buster 812 asking for money with some characteristic of creditability associated with that call, that may make Buster 812 relax his internal “scam detector” and be scammed.

Consider the following: Amit 807 and Buster 812 are friends. If the fraudster 810 steals Amit's smartphone 808 and calls and says Amit 807 is hurt and needs money, the fraudster 810 knows that this scenario might make Buster 812 ask for some supporting information before he sends anything of value. This is true because the financial transaction initiation communication came from a random person from a known number. Buster 812 is equipped with an excellent “scam detector,” so this may scream “stolen phone” to him.

Now consider this situation: Amit 807 and Buster 812 are still friends. However, Amit 807 has a brother. The fraudster 810 steals Amit's brother's phone and calls Buster 812 alleging that Amit 807 is hurt and needs money. While this could work, if Buster 812 knows Amit's brother well enough to have his number stored in his contacts list, he probably would also recognize Amit's brother's voice. Thus, Buster 812 know it was a scam. Buster 812 could just ask, “well, if Amit's hurt, why don't you just let me send the money to his phone because he's my buddy and I know he wouldn't scam me.” After all, if Amit 807 is truly hurt, his device should be available (if it wasn't damaged).

Sadly, in the scenario depicted in FIG. 8, the fraudster 810 is a crackerjack at his craft. He's betting that Buster 812 and Amit 807 are friends and that Buster 812 only knows Amit's brother in passing. However, the fraudster 810 assumes Amit 807 and the brother run with a group of friends that includes a really great guy named Mac. Buster 812 may not have Amit's brother's number stored in the contacts list but may have spoken to him occasionally in passing. Thus, at step 803 the fraudster 810 calls Buster's electronic device 813.

As shown at step 804, Buster 812 gets a call from a random number from a person (the fraudster 810) who sounds like Amit's brother. However, having only spoken to Amit's brother in passing, despite having excellent “scamdar,” which is short for “scam radar,” Buster 812 cannot be sure. As shown at step 803, the fraudster 810 asks for money for Mac, alleging he's hurt and in the intensive care unit. Buster 812 has heard of Mac but doesn't know him personally (the fraudster 810 got the name by scrolling through recent calls in Amit's phone 808).

The fraudster 810 understands that there is a point of credibility in that (1) the fraudster 810 sounds like Amit's brother and (2) knows of a friend in the group. However, Buster 812 doesn't really know either, so can't confirm these facts. Accordingly, as shown at step 804 Buster 812 sadly falls into the trap set by the fraudster 810 based on these prima facie facts. Buster therefore sends the money to the electronic device identifier the fraudster 810 transmitted from Amit's phone 808.

As shown at step 805, Buster 812 later receives a text message 814 from Amit 807 (who has purchased a new phone by now), saying, “Dude! My phone was stolen! Hope you didn't send any money my way.” As shown at step 806, poor Buster 812 now understands he has been scammed. Downtrodden and depressed, he texts Amit 807 back for the details of that delicious sounding caramel macchiato. Buster 812 knows he could use one to cheer himself up.

Sadly, situations such as Buster's are all too common. The India Times.sup.™ reports that by using a mix of malicious applications and fraudulent customer care phone numbers cyber criminals duped a garment dealer out of 150,000 Indian Rupee (over eighteen hundred US dollars) while he was trying to book a railway ticket. Had the garment dealer been equipped with an electronic device configured in accordance with embodiments of the disclosure, he would have been alerted to the fraud and would have been able to prevent his money from being stolen.

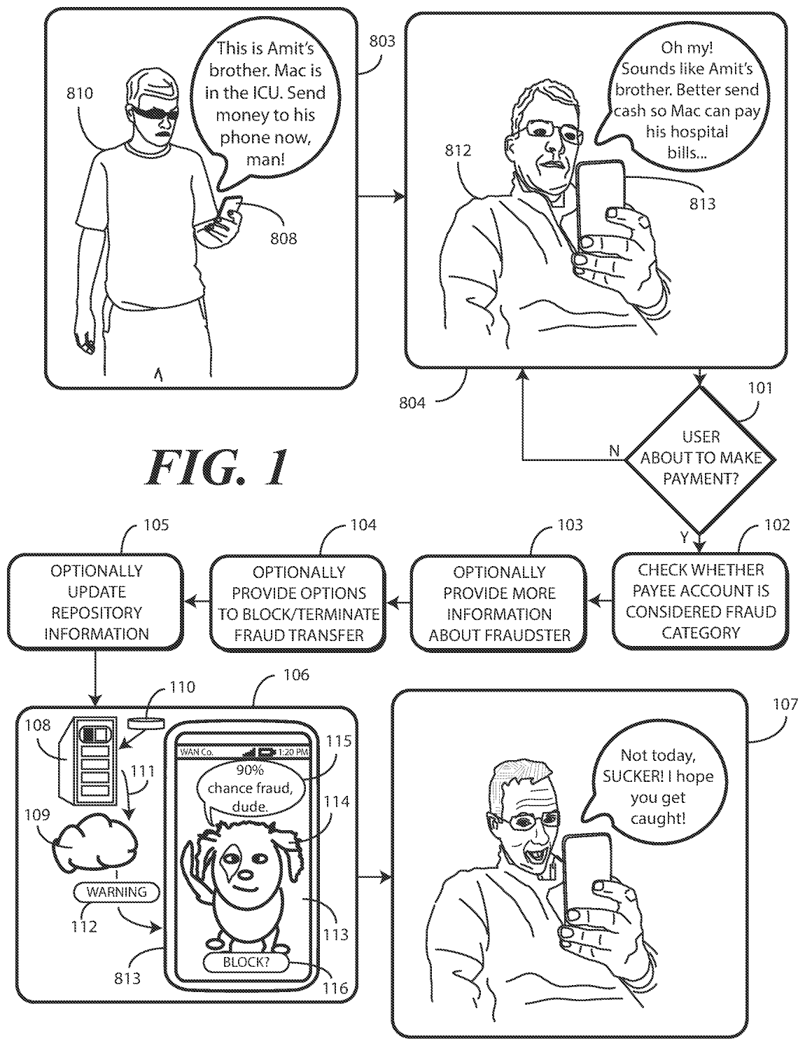

Fortunately, embodiments of the disclosure provide a solution to these problems. In one or more embodiments a method in an electronic device comprises detecting, with a communication device of the electronic device in communication with at least one remote electronic device, initiation of an electronic financial transaction across a network to an account having an account identifier. The one or more processors of the electronic device, in response to the detecting, query the account identifier to determine if the account is associated with fraudulent activity. If the account is associated with the fraudulent activity, in one or more embodiments the one or more processors cause the communication device to transmit a fraud warning to the electronic device prior to the electronic financial transaction being completed. Turning now to FIG. 1, illustrated therein are one or more method steps depicting how the dreadful situation illustrated in FIG. 8 can be avoided using embodiments of the disclosure.

FIG. 1 begins with step 803 of FIG. 8. At step 803, the fraudster 810 (still without that terrible hat (811), thank goodness), is scrolling through Amit's smartphone 808 to look through contacts and finds a frequently called friend named Buster 812, who is shown at step 804.

As shown at step 804, Buster 812 gets a call from a random number from a person (the fraudster 810) who sounds like Amit's brother. Having only spoken to Amit's brother in passing, Buster 812 cannot be sure. As shown at step 803, the fraudster 910 makes a call, which causes the presentation of an electronic device identifier (here, Amit's brother's telephone number) and asks for money for Mac, alleging he's hurt and in the intensive care unit. Buster 812 has heard of Mac but doesn't know him personally (the fraudster 810 got the name by scrolling through recent calls in Amit's phone 808).

Since Buster 812 doesn't really know either person, he is unable to confirm these facts. Accordingly, as shown at step 804 Buster 812 once again falls into the trap set by the fraudster 810 and begins to send the money to the electronic device identifier the fraudster 810 transmitted from Amit's phone 808 by making the call. Buster 812 opens a financial application and initiates a transaction to transfer money to the electronic device identifier.

Fortunately, here Buster's electronic device 813 operates as a remote electronic device in communication with another electronic device 108, which is configured as a server complex in this illustrative example. At decision 101 electronic device 108 detects, with a communication device in communication with Buster's electronic device 813, initiation of the electronic financial transaction to an account having an account identifier by Buster 812. Examples of account identifiers can include an account number, a combined account number and routing number, an account number and a SWIFT code, or other indicia allowing funds to be directed to a financial account. Other examples of such account identifiers will be obvious to those of ordinary skill in the art having the benefit of this disclosure.

At step 102, one or more processors of the electronic device 108 query the account identifier to determine if the account is associated with fraudulent activity. This step 102 can be done in a variety of ways.

In this illustrative embodiment, the fraudster 810 is asking for money to be transferred to Amit's phone 808, which is identified by an electronic device identifier. As with the account identifier, the electronic device identifier can take a variety of forms. In a simple embodiment, the electronic device identifier can simply be Amit's phone number. However, since phone numbers can be easily transferred between devices, such as by switching a subscriber interface module (SIM) card, the electronic device identifier can take other forms as well. In other embodiments, the electronic device identifier is an anonymous string of numbers and letters that uniquely identifies a mobile device. In other embodiments, the electronic device identifier can be the identifier for advertisers (IDFA) promulgated by Apple.sup.™, the advertising identifier promulgated by Google.sup.™, the international mobile equipment identity (IMEI), a device serial number, or a secure identifier generated by a unique token that identifies an electronic device. Other examples of electronic device identifiers will be obvious to those of ordinary skill in the art having the benefit of this disclosure.

In this example the initiation of the electronic financial transaction occurs in response to an electronic communication (the fraudster's phone call) received by Buster's electronic device 813 having the electronic device identifier. During this phone call, Amit's phone 808 could be identified to Buster's electronic device 813 using any of the electronic device identifier referenced above or others that will be obvious to those of ordinary skill in the art having the benefit of this disclosure.

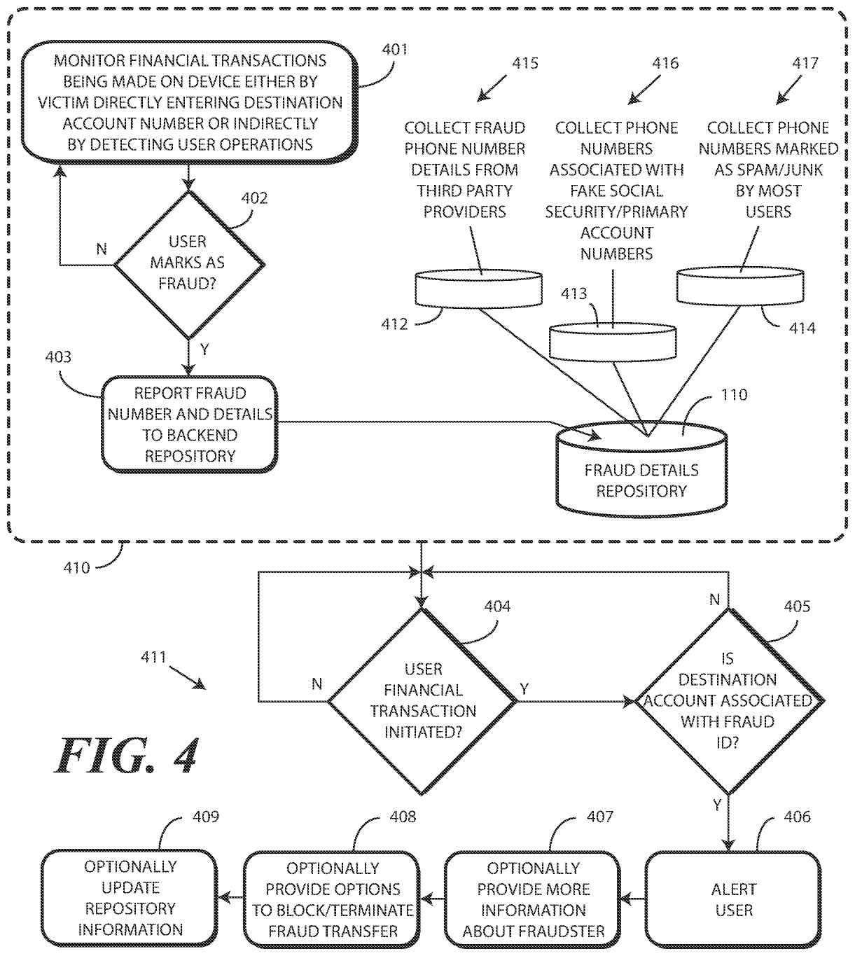

As will be described in more detail below with reference to FIG. 4, in one or more embodiments the electronic device 108 has access to a functional database 110. Accordingly, the querying occurring at step 102 can comprise utilizing this functional database 110 to determine whether the electronic device identifier has been associated with past fraudulent activity.

In one or more embodiments, the functional database 110 compiles at least a first set of electronic device identifiers associated with falsified account or personal identification numbers, a second set of electronic device identifiers having associated therewith reports of fraudulent activity, optionally in numbers exceeding a predefined report threshold, and a third set of electronic device identifiers verified as being associated with fraud by a third party. At step 102, the one or more processors of the electronic device 108 can query the functional database to determine whether the electronic device identifier is found in the first set of electronic device identifiers, the second set of electronic device identifiers, or the third set of electronic device identifiers.

In other embodiments, the functional database 110 can also include phone numbers associated with fake Social Security numbers or Primary Account Numbers from authorized government agencies. In one or more embodiments, the functional database 110 also includes phone numbers of criminals determined from authorized government agencies, examples of which include police databases and court databases.

In still other embodiments, electronic device 108 determines that an account associated with the electronic financial transaction is associated with possible fraudulent activity by comparing the account to a functional database including one or more of: phone numbers that are marked as “spam” or marked as “junk” by all mobile users receiving incoming calls from an unknown number. Such spam or junk or fraud phone numbers can be identified in one or more embodiments by authorized third-party service providers, examples of which include TrueCaller.sup.™, WhatsApp.sup.™, GoogleCaller.sup.™, and others.

In one or more embodiments, the electronic device 108 categorizes an account as being associated with fraudulent activity based upon reports by verified users with fraudster bank account details after the verified users made a transaction to a fraudster account by getting duped. In one or more embodiments, such reports are considered verified when a threshold number of such reports are received.

In this illustrative embodiment, Amit (807) (after finishing his caramel macchiato, of course) has alerted the police to the fact that his phone 808 has been stolen. Accordingly, the electronic device identifier associated with Amit's phone 808 is found in the both the second set of electronic device identifiers having associated therewith reports of fraudulent activity and the third set of electronic device identifiers verified as being associated with fraud by a third party. Accordingly, since the account is associated with fraudulent activity, the one or more processors of electronic device 108 cause the communication device to transmit 111 a fraud warning 112 to Buster's electronic device 813 prior to the electronic financial transaction detected at decision 101 being completed.

In this illustrative example, the fraud warning 112 comprises a prompt 114 presented on a user interface 113 of Buster's electronic device 813. The prompt 114 includes a warning 115 of fraudulent activity. In this illustrative example, the warning 115 includes a warning level based upon a fraud ranking. Here the warning level indicates that there is a ninety-percent chance that the electronic financial transaction is associated with fraudulent activity since there is that chance that the Amit's phone 808 is still stolen and has not been returned to him. This warning 115 thus identifies whether the electronic device identifier was found in the first set of electronic device identifiers, the second set of electronic device identifiers, or the third set of the electronic device identifiers of the functional database 110.

In this illustrative embodiment, the prompt 114 also includes a user actuation target 116 allowing the electronic financial transaction to be terminated. In one or more embodiments, when Buster 812 actuates the user actuation target 116, the one or more processors of electronic device 108 cause the electronic financial transaction initiated at step 804 to be terminated.

Fortunately, here the one or more processors of electronic device 108 cause presentation of the prompt 114 before a financial transaction associated with the electronic financial transaction is completed. Accordingly, Buster 812 with his excellent “scamdar,” immediately actuates the user actuation target 116 provided by the prompt to terminate the financial transaction associated with the electronic financial transaction started with a financial transaction initiation communication detected at decision 101. This terminates the electronic financial transaction. As shown at step 107, Buster 812 is elated. He exclaims, “Not today, sucker! I hope you get caught.” After successfully thwarting the fraud using embodiments of the disclosure, he decides to treat himself to another caramel macchiato.

Other steps can optionally be performed in addition to the presentation of the prompt 114. Illustrating by example, optional step 103 can provide additional details about the fraudster and/or past fraudulent activity. For example, step 103 might indicate that Amit's phone was stolen from Henry's Block House café while Amit was waiting for his complicated caramel macchiato. Step 103 might cause the camera of Amit's phone 808 to take a picture of the fraudster 810 and send that to Buster's electronic device 813 as well. In other embodiments, step 103 can include sending Buster 812 a notification that an unauthorized user has been positively confirmed as operating Amit's phone 808. Step 103 can comprise delivering other information, such as an image of the fraudster 810, a location of Amit's phone 808, sounds recorded by one or more microphones of Amit's phone 808, or other data. This alerts Buster 812 to the fact that Amit's phone 808 may have been stolen.

At step 104, additional optional operations can be performed. In one or more embodiments, step 104 identifies whether the electronic device identifier associated with the financial transaction is found in the functional database 110, and in particular whether the electronic device identifier was found in the first set of electronic device identifiers, the second set of electronic device identifiers, or the third set of electronic device identifiers. Step 104 can also provide an option allowing the financial transaction to be terminated, one example of which was the inclusion of the user actuation target 116 with the prompt 114 at step 106.

In one or more embodiments, step 104 can transmit electronic communications to Amit's phone causing it to enter a powered OFF emulation mode. In one or more embodiments, this emulation mode disables user interface output devices of Amit's phone 808 while keeping one or more input devices operational. This allows the one or more processors of Amit's phone 808 to monitor one or more inputs from an environment.

Step 104 can include precluding erasure of data stored in a memory of Amit's phone 808 or precluding a factory reset of Amit's phone 808. Step 104 can include transmitting, across the network 109 with a wireless communication circuit, data representations of the one or more inputs received by Amit's phone 808. Data representations, such as images, video files, audio files, location information, weather information, motion, and so forth, can then be transmitted to a remote electronic device such Buster's electronic device 813 or a cloud-computing device. Other operations that can be performed at step 104 will be obvious to those of ordinary skill in the art having the benefit of this disclosure.

At step 105, the functional database 110 can be updated with the fact that Buster 812 has terminated an electronic financial transaction using the prompt 114 due to the fact that the account identifier associated with the account of the financial transaction was being used for fraudulent activity. This allows the functional database 110 to be continually updated with relevant information that can be used to stop the completion of financial transactions that are initiated by financial transaction initiation communications.

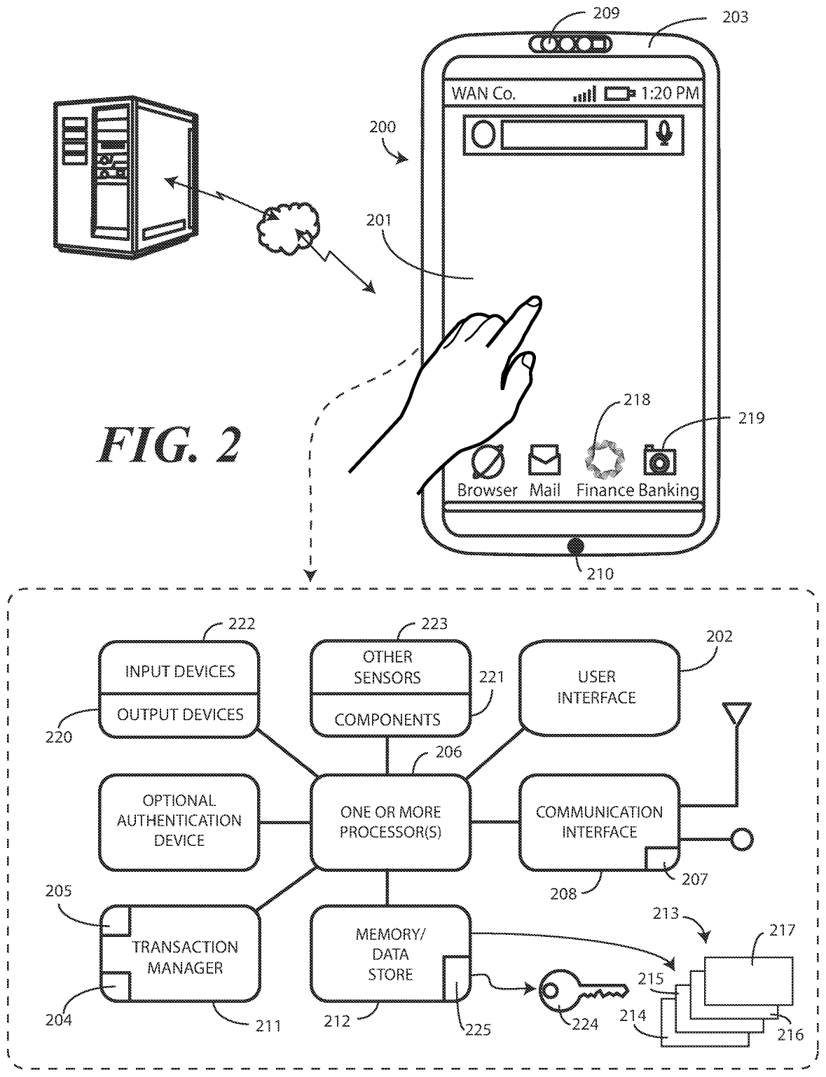

Turning now to FIG. 2, illustrated therein is one electronic device 200 configured in accordance with one or more embodiments of the disclosure. The electronic device 200 of this illustrative embodiment includes a user interface 202. In one or more embodiments, the user interface 202 comprises a display 201, which may optionally be touch-sensitive. The display 201 can serve as a primary user interface 202 of the electronic device 200.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 includes a housing 203. Features can be incorporated into the housing 203. Examples of features that can be included along the housing 203 include an imager 209, shown as a camera in FIG. 2, or an optional speaker port. A user interface component 210, which may be a button or touch sensitive surface, can also be disposed along the housing 203.

A block diagram schematic of the electronic device 200 is also shown in FIG. 2. In one embodiment, the electronic device 200 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 200. Each of the application processor and the auxiliary processor(s) can be configured to process and execute executable software code to perform the various functions of the electronic device 200. A storage device, such as memory 212, can optionally store the executable software code used by the one or more processors 206 during operation.

In this illustrative embodiment, the electronic device 200 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas.

The electronic device 200 can optionally include a near field communication circuit 207 used to exchange data, power, and electrical signals between the electronic device 200 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 200. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 200.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 200, an electronic mail application configured to send and receive electronic mail, a photo application configured to organize, manage, and present photographs on the display 201 of the electronic device 200, and a camera application for capturing images with the imager 209. Collectively, these applications constitute an “application suite.”

In one or more embodiments, these applications comprise one or more financial applications 218 and/or banking applications 219 that allow financial transactions to be made using the electronic device 200. Illustrating by example, in one or more embodiments a user can deliver user input to a financial application 218 or a banking application 219 to initiate a financial transaction initiation communication. In one or more embodiments, when this occurs the communication device 208 transmits a financial transaction initiation communication 204 generated by a transaction manager 211. In one or more embodiments, the financial transaction initiation communication 204 comprises an electronic device identifier 224 from which a financial transaction initiation request 225 was received by the communication device 208. When the financial transaction initiation request 225 includes an account identifier 205, the transaction manager 211 can extract this account identifier 205 from the financial transaction initiation request 225 and include it with the financial transaction initiation communication 204.

In one or more embodiments, the one or more processors 206 are responsible for managing the applications and all personal information received from the user interface 202 that is to be used by the finance application 218 and/or banking application 219 after the electronic device 200 is authenticated as a secure electronic device and the user identification credentials have triggered a login event. The one or more processors 206 can also be responsible for launching, monitoring and killing the various applications and the various application service modules. In one or more embodiments, the one or more processors 206 are operable to not only kill the applications, but also to expunge any and all personal data, data, files, settings, or other configuration tools when the electronic device 200 is reported stolen or when the finance application 218 and/or banking application 219 are used with fraudulent activity to wipe the memory 212 clean of any personal data, preferences, or settings of the person previously using the electronic device 200.

The one or more processors 206 can also be operable with other components 221. The other components 221, in one embodiment, include input components 222, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 223, which may include key selection sensors, touch pad sensors, capacitive sensors, motion sensors, and switches. Similarly, the other components 221 can include video, audio, and/or mechanical outputs 220.

The one or more sensors 223 may include, but are not limited to, accelerometers, touch sensors, surface/housing capacitive sensors, audio sensors, and video sensors. Touch sensors may be used to indicate whether the electronic device 200 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 200.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

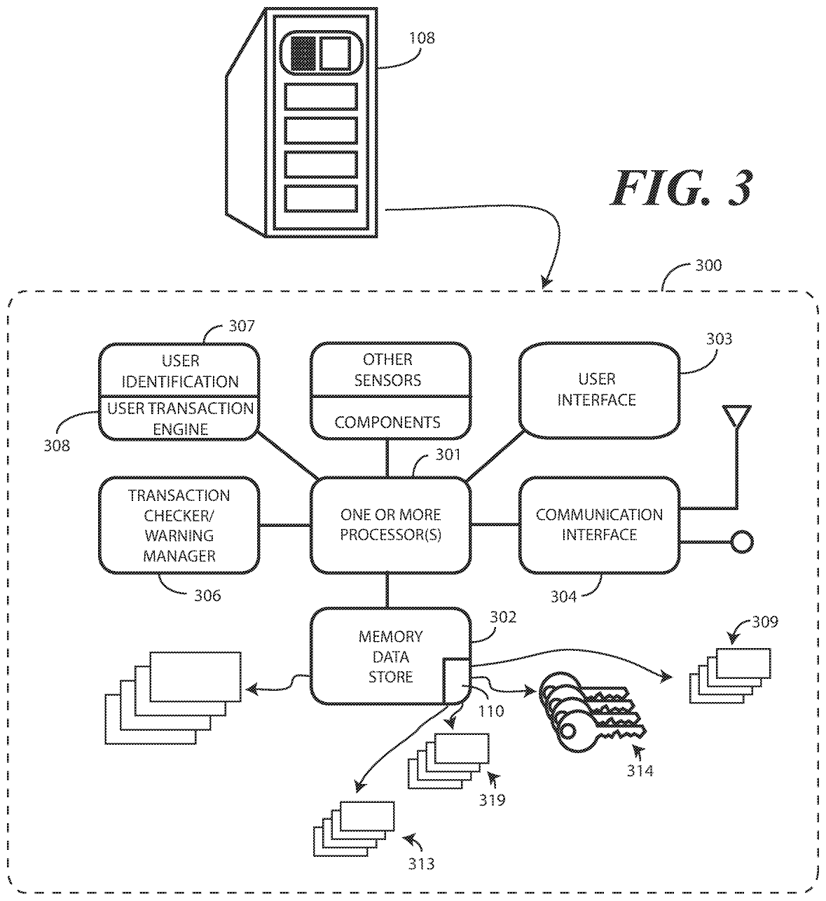

Turning now to FIG. 3, illustrated therein is one remote electronic device 108 with which the electronic device (200) of FIG. 2 may communicate across a network (109). The remote electronic device 108 is illustrated as a cloud server in FIG. 3. However, in other embodiments, the remote electronic device can be another type of computer, server, a server complex, network hub, or other computing device configured to authenticate one or more electronic devices as secure or trusted electronic devices.

An illustrative schematic block diagram 300 is also shown in FIG. 3. As with the block diagram schematic of FIG. 2, it is to be understood that the schematic block diagram 300 of FIG. 3 is provided for illustrative purposes only and for illustrating components of one explanatory cloud server configured in accordance with one or more embodiments of the disclosure. Accordingly, the components shown in either FIG. 2 or FIG. 3 are not intended to be complete schematic diagrams of the various components required for a particular device, as other devices configured in accordance with embodiments of the disclosure may include various other components not shown in FIG. 2 or FIG. 3. Alternatively, other remote electronic devices configured in accordance with embodiments of the disclosure or may include a combination of two or more components or a division of a particular component into two or more separate components, and still be within the scope of the present disclosure.

In one or more embodiments, the electronic device 108 includes one or more processors 301, one or more memory devices 302, and one or more user interface devices 303, e.g., a display, a keyboard, a mouse, audio input devices, audio output devices, and alternate visual output devices. The electronic device 108 also includes a communication device 304. These components can be operatively coupled together such that, for example, the one or more processors 301 are operable with the one or more memory devices 302, the one or more user interface devices 303, and/or the communication device 304 in one or more embodiments.

The one or more processors 301 can include a microprocessor, a group of processing components, one or more ASICs, programmable logic, or other type of processing device. The one or more processors 301 can be configured to process and execute executable software code to perform the various functions of the electronic device 108.

The one or more memory devices 302 can optionally store the executable software code used by the one or more processors 301 in carrying out the operations of authenticating electronic devices as secure or trusted electronic devices. The one or more memory devices 302 may include either or both of static and dynamic memory components, as well as one or more encrypted memory devices 302. The one or more memory devices 302 can store both embedded software code and user data. The software code can embody program instructions and methods to operate the various functions of the terminal device, and also to execute software or firmware applications and modules such as the user identification engine 307, the user transaction engine 308, and the transaction warning manager 306.

In one or more embodiments, the communication device 304 comprises any of a number of wired or wireless technologies for communication. Examples of these technologies include wired plain old telephone service (POTS) technologies, wired Ethernet technologies such as those configured in accordance with the IEEE 802.11 networking standards, peer-to-peer or ad hoc communications, frequency modulated communication, amplitude modulated communication, or IEEE 802.11 wireless communication. Other forms of communication technologies suitable for inclusion with the communication device 304 will be obvious to those having the benefit of this disclosure. The communication device 304 can include wired or wireless communication circuitry, one of a receiver, a transmitter, or transceiver. Where wireless, the communication device 304 can include one or more antennas.

In one or more embodiments, the communication device 304 is operable to establish electronic communication with an electronic device (200) across a network (109). In one or more embodiments, the communication device 304 is operable to receive a financial transaction initiation communication from at least one remote electronic device (200) comprising an electronic device identifier from which a financial transaction initiation request was received by the at least one remote electronic device (200). Thereafter the one or more processors 301 can determine whether the electronic device identifier is associated with an account identifier of an account used for fraud.

In one or more embodiments the cloud server can be configured for performing processor-intensive methods, operations, steps, functions, or procedures associated with receiving a financial transaction initiation communication from at least one remote electronic device, e.g., electronic device (200), in communication with the communication device 208 of the electronic device 108 across a network (109). In one or more embodiments, the financial transaction initiation communication comprises an electronic device identifier from which a financial transaction initiation request was received by the at least one remote electronic device.

In one or more embodiments, the one or more processors 301 of the electronic device 108 can query, in response to the financial transaction initiation communication, a functional database 110. In one or more embodiments, the functional database 110 is a construction of at least a first set 309 of electronic device identifiers associated with falsified account or personal identification numbers, a second set 313 of electronic device identifiers having associated therewith reports of fraudulent activity, optionally in quantities exceeding a predefined report threshold, and a third set 319 of electronic device identifier verified as being associated with fraud by a third party. In one or more embodiments, the electronic device identifiers stored in the functional database 110 are verified by a third-party source. In one or more embodiments, the functional database 110 also includes a set 314 of account identifiers of accounts associated with fraudulent activity as well.

In one or more embodiments, the one or more processors 301 use the functional database 110 to determine whether an electronic device identifier associated with an electronic communication comprising a financial transaction initiation communication has been associated with past fraudulent activity. In one or more embodiments, a transaction warning manager 306 determined that the electronic device identifier has been associated with past fraudulent activity when a plurality of remote electronic device in communication with the electronic device 108 having a quantity exceeding a predefined threshold has transmitted electronic communications to the communication device 304 indicating that the electronic device identifier in question is suspect of being used fraudulently. One such communication would be Amit's report of his phone (808) being stolen.

In one or more embodiments, the transaction warning manager 306 determines that the electronic device identifier in question has been associated with the past fraudulent activity when a third-party server, examples of which will be described below with reference to FIG. 4, that is in communication with the communication device 304, confirms that the electronic device identifier has been used fraudulently. In one or more embodiments, this third-party server is a government operated server, examples of which include police databases and court databases. In still other embodiments, the transaction warning manager 306 determines that an electronic device identifier in question has been associated with the past fraudulent activity when the electronic device identifier is associated with a falsified account number or personal identification number found in the functional database 110.

In one or more embodiments when the communication device 208 receives a financial transaction initiation communication from at least one remote electronic device comprising an electronic device identifier from which a financial transaction initiation request was received by the at least one remote electronic device, the transaction warning manager 306 determines whether the electronic device identifier is associated with an account identifier of an account used for fraud. This can be done by referencing the set 314 of account identifiers in the functional database 110 or the other data stored in the functional database 110 in one or more embodiments.

Illustrating by example, the transaction warning manager 306 can query the functional database 110 in response to a financial transaction initiation communication to determine whether the electronic device identifier is found in the first set 309 of electronic device identifiers, the second set 313 of electronic device identifiers, or the third set 319 of electronic device identifiers. When the electronic device identifier is found in the first set 309 of electronic device identifiers, the second set 313 of electronic device identifiers, or the third set 319 of electronic device identifiers, the transaction warning manager can cause the communication device 304 to present a prompt on the at least one electronic device from which the financial transaction initiation communication was received warning of fraudulent activity.

Turning now to FIG. 4, illustrated therein are one or more explanatory method steps in accordance with one or more embodiments of the disclosure. The method steps are broken down into a training phase 410 for the functional database 110 and an action phase 411 when the functional database 110 is being used to determine whether an account identifier associated with an account and/or an electronic device identifier is being used in conjunction with fraudulent activity.

In the training phase 410, step 401 comprises monitoring financial transactions being made on remote electronic devices directly and indirectly. Financial transactions can be monitored directly when people manually enter destination account numbers. They can be monitored indirectly by detecting other user operations. Decision 402 then determines whether the user making the financial transactions being monitored at step 401 marks the financial transaction as being associated with fraudulent activity. Where they do, step 403 creates a fraud report for storage and construction in the functional database 110. Otherwise, monitoring continues at step 401.

The functional database 110 can be in communication with other functional databases as well. Examples include third-party functional databases 412, functional databases 413 that are government operated, and functional database 414 storing user activity. Illustrating by example, if decision 402 determines a user marks a financial transaction as fraudulent, this can be included in a collection 417 of electronic device identifiers that have been marked as spam and junk by users.

In one or more embodiments, for an electronic device identifier to be added to this collection 417 of electronic device identifiers that have been marked as spam and junk by users, it requires a requisite number of such markings before the addition is made. Said differently, in one or more embodiments inclusion in the collection 417 of electronic device identifiers that have been marked as spam and junk by users requires a plurality of remote electronic devices having a quantity exceeding a predefined threshold having transmitted electronic communications to the functional database 414 indicating that the electronic device identifier is suspected of being used fraudulently.

In other embodiments, the third-party can confirm that the electronic device identifier has been used fraudulently in its functional database 412. This can be done in a construction of a collection 415 of electronic device identifiers verified by a third-party as being used fraudulently. Another collection 416 of electronic device identifier associate with fake Social Security numbers and/or primary account numbers can be assimilated from a functional database 413 of a government operated server, examples of which include police databases, court databases, government databases, and the like.

Once the functional database 110 is created, it can be implemented in the action phase 411. Decision 404 determines whether a financial transaction is initiated. In one or more embodiments, this comprises receiving a financial transaction initiation communication from at least one remote electronic device comprising an electronic device identifier from which a financial transaction initiation request was received by the at least one remote electronic device.

Decision 405 then determines whether the electronic device identifier is associated with the account identifier of an account used for fraud. In one or more embodiments, this decision comprises querying the account identifier to determine if the account identifier is associated with fraudulent activity by utilizing the functional database 110 to determine whether the electronic device identifier has been associated with past fraudulent activity.

Illustrating by example, decision 405 can comprise determined that the electronic device identifier has been associated with the past fraudulent activity when functional database 414 indicates that a plurality of remote electronic devices having a quantity exceeding the predefined threshold has transmitted electronic communications, determined by decision 402, have transmitted electronic communications indicating that the electronic device identifier is suspected of being used fraudulently. Similarly, decision 405 can determine that the electronic device identifier has been associated with the past fraudulent activity when functional database 413, the third-party server complex, confirms that the electronic device identifier has been used fraudulently. This can also be done when the functional database 413 is a government operated server, such as would be the case when the electronic device identifier is associated with a falsified account number, Social Security number, or personal identification number.

Step 406 comprises causing the presentation of a prompt on the electronic device attempting to complete the financial transaction warning of fraudulent activity. In one or more embodiments, the prompt presented at step 406 is presented before a financial transaction associated with the financial transaction initiation communication is completed. In one or more embodiments, as described above, the prompt can include a user actuation target allowing the financial transaction to be terminated.

Step 407 can then comprise optionally providing additional information about the fraudster. If the prompt includes a user actuation target allowing the financial transaction to be terminated, step 408 can comprise causing the financial transaction to be terminated when the user actuation target is actuated. The functional database 110 can be continually updated at step 409.

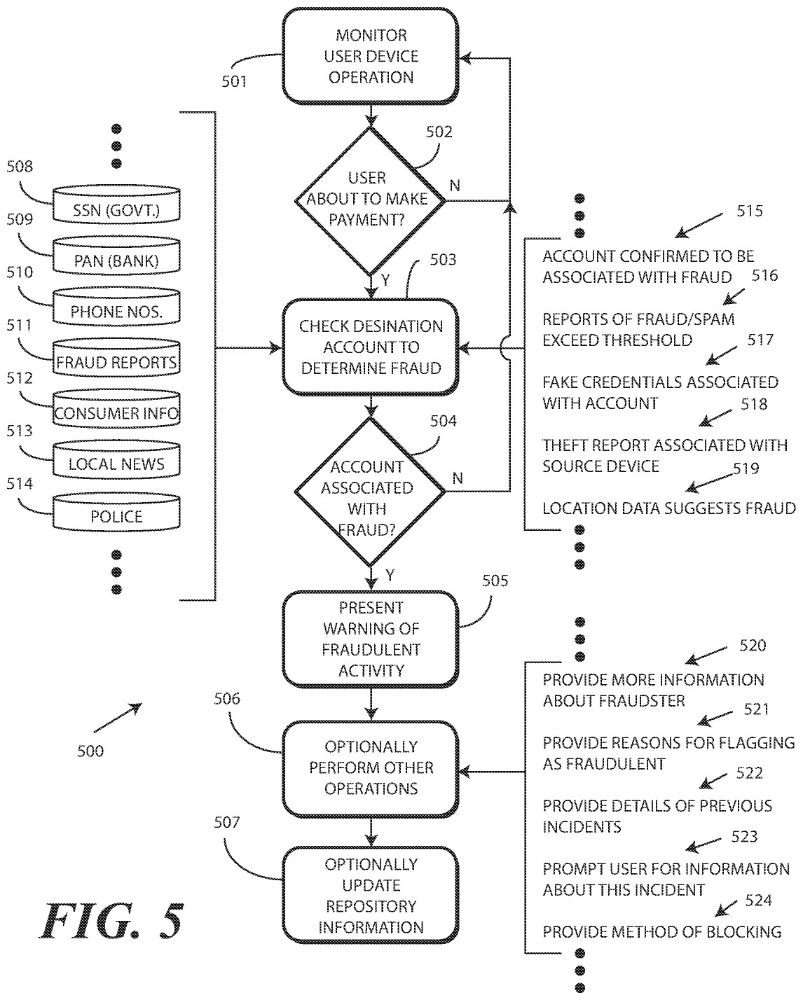

Turning now to FIG. 5, illustrated therein is another method 500 in accordance with one or more embodiments of the disclosure. The method 500 of FIG. 5 can be used in an electronic device (108) configured, for example, as the server complex of FIGS. 1 and 3 above.

At step 501, operation of one or more embodiments remote electronic devices is monitored. Decision 502 determines from the monitoring occurring at step 501 whether a user is about to execute a financial transaction transferring money to an account having an account identifier.

This decision 502 can comprise detecting, with a communication device in communication with at least one remote electronic device, initiation of an electronic financial transaction across a network to the account having the account identifier in one or more embodiments. In other embodiments, this decision 502 can be made when a financial transaction initiation communication is received from at least one remote electronic device comprising an electronic device identifier from which a financial transaction initiation request was received by the remote electronic device. In other embodiments, this decision 502 can be affirmatively made when a communication device receives a financial transaction initiation communication from at least one remote electronic device. Other techniques for determining an electronic financial transaction is being made will be obvious to those of ordinary skill in the art having the benefit of this disclosure.

Step 503 determines whether the account to which the electronic financial transaction is directed is associated with fraud. In one or more embodiments, step 503 consults with one or more server complexes to make this determination. Examples include government operated server complexes 508,514 that include reports of social security numbers being used fraudulently, police reports of crime, court reports of convictions, and so forth. They can include third party server complexes, including bank-operated server complexes 509 indicating that primary account numbers have been sued fraudulently, third-party server complexes 510 indicating that electronic device identifiers have been fraudulently used, consumer information server complexes 512, user-initiated fraud report server complexes 511, and even local news server complexes 513 reporting financial crimes. This list is illustrative only, as other sources from which fraudulent activity can be detected will be obvious to those of ordinary skill in the art having the benefit of this disclosure.

The information stored in such sources can include confirmed fraud reports 515 associated with the account or account identifier, reports 516 of fraudulent activity exceeding a predefined threshold number, fake credentials 517 associated with the account or account identifier, theft reports 518 of electronic devices having the electronic device identifier associated with the financial transaction initiation request, or even location data 519 associated with the electronic device having the electronic device identifier associated with the financial transaction initiation request.

Decision 504 determines whether the account corresponding to the financial transaction initiation request is associated with fraudulent activity. This decision 504 can include querying the account identifier to determine if the account is associated with fraudulent activity in one or more embodiments. This decision 504 can also include querying one of the functional databases operating on the aforementioned server complexes as well.

When fraud is suspected, step 505 warns the user. This can include, if the account is associate with fraudulent activity, causing a fraud warning to be presented on a user interface of the electronic device initiating the financial transaction.

Step 506 can then perform other operations. Examples include providing more information 520 about the fraudster, providing reasons 521 for flagging the financial transaction as fraudulent, providing details 522 of previous fraudulent incidents, and other information. Step 506 can prompt 523 the user for additional information about the present transaction so that a functional database constructed to include at least a first set of electronic device identifiers associated with falsified account or personal identification numbers, a second set of electronic device identifiers having associated therewith reports of fraudulent activity exceeding a predefined report threshold, and a third set of electronic device identifiers verified as being associated with fraud by a third party can be updated in real time at step 507. Additionally, as previously described, the prompt presented at step 505 can include a method 524. of precluding the financial transaction from being completed.

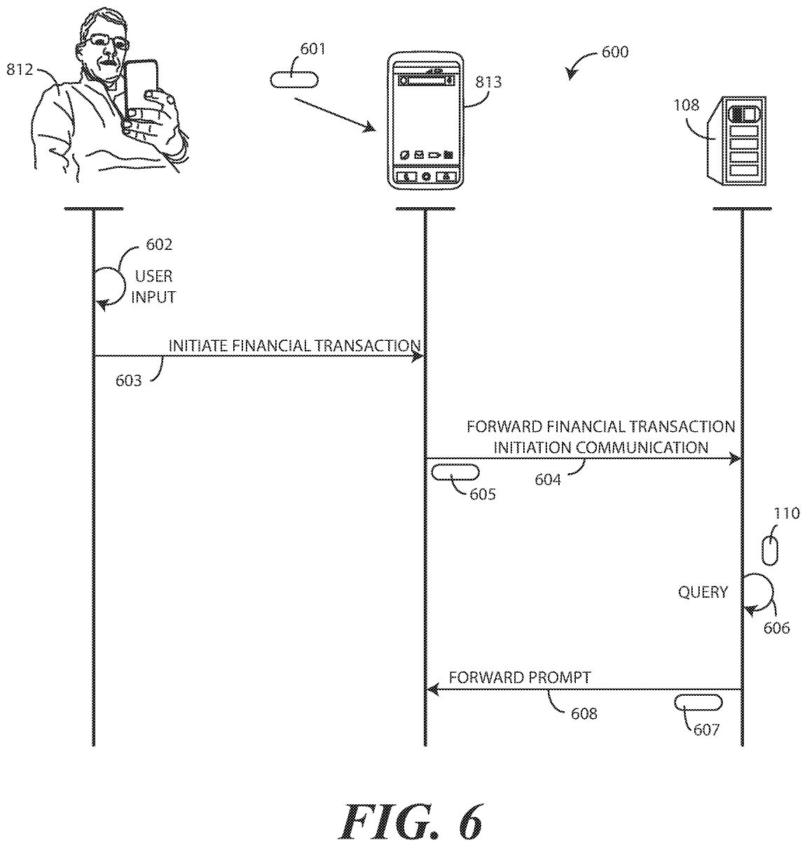

Turning now to FIG. 6, illustrated therein is one explanatory flow diagram 600 illustrating how methods in accordance with embodiments of the disclosure can be implemented. The flow diagram 600 shows Buster 812, his electronic device 813, and a remote electronic device 108 in communication with electronic device 813.

Initially, Buster's electronic device 813 receives a financial transaction initiation request 601 from a fraudster. If his scamdar is not working properly, he delivers user input 602 to the user interface of his electronic device 813 to initiate 603 a financial transaction. Since his electronic device 813 is in communication with remote electronic device 108, remote electronic device 108 receives 604 a financial transaction initiation communication 605 from the electronic device 813.

In one or more embodiments, electronic device 108 then queries 606 a functional database 110 to determine whether an electronic device identifier identified by the financial transaction initiation communication is associated with fraudulent activity. Where it is, electronic device 108 uses a communication device to cause 608 electronic device 813 to present a prompt 607 warning of fraudulent activity.

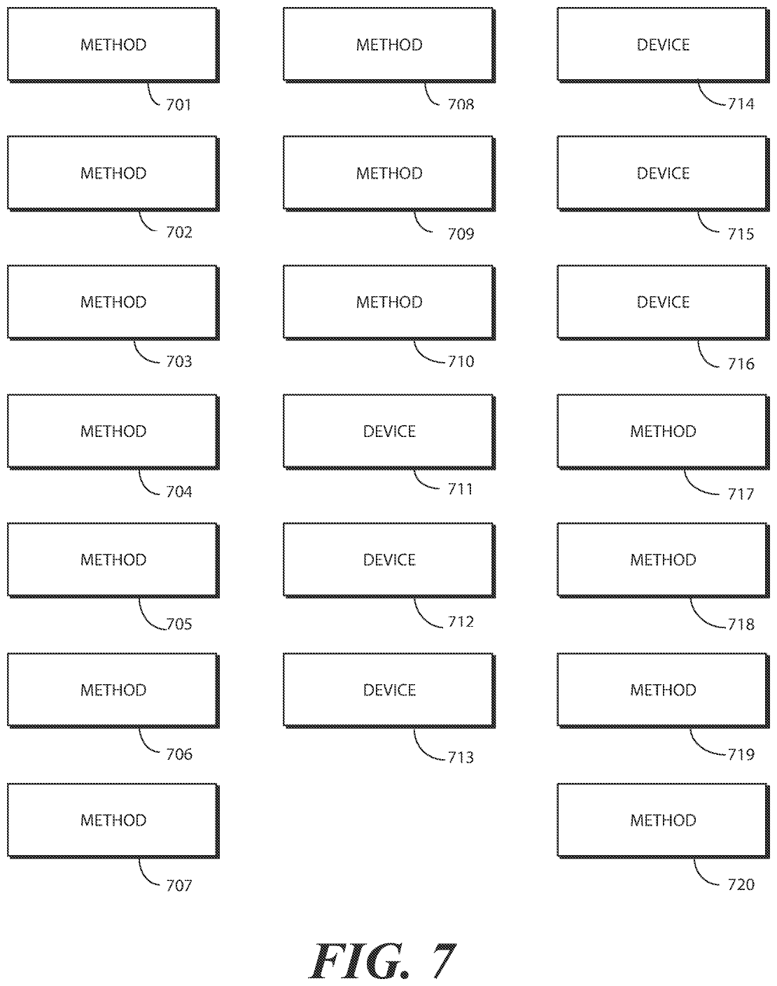

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method comprises detecting, with a communication device of an electronic device in communication with at least one remote electronic device, initiation of an electronic financial transaction across a network to an account having an account identifier. At 701, the method comprises querying, by one or more processors of the electronic device in response to the detecting, the account identifier to determine if the account is associated with fraudulent activity. At 701, if the account is associated with the fraudulent activity, the method comprises causing, by the one or more processors, the communication device to transmit a fraud warning to the remote electronic device prior to the electronic financial transaction being completed.

At 702, the initiation of the financial transaction of 701 occurs in response to an electronic communication received by the at least one remote electronic device from at least one other remote electronic device having an electronic device identifier. At 703, the querying of 702 comprises utilizing a functional database to determine whether the electronic device identifier has been associated with past fraudulent activity.

At 704, the method of 703 further comprises determining that the electronic device identifier has been associated with the past fraudulent activity when a plurality of remote electronic devices in communication with the electronic device having a quantity exceeding a predefined threshold has transmitted electronic communications to the communication device indicating that the electronic device identifier is suspected of being used fraudulently.

At 705, the method of 703 further comprises determining that the electronic device identifier has been associated with the past fraudulent activity when a third-party server complex in electronic communication with the communication device confirms that the electronic device identifier has been used fraudulently. At 706, the determining that the electronic device identifier has been associated with the past fraudulent activity of 705 occurs only when the third-party server is a government operated server.

At 707, the method of 703 further comprises determining that the electronic device identifier has been associated with the fraudulent activity when the electronic device identifier is associated with a falsified account number or personal identification number. At 708, the fraud warning of 703 comprises a prompt presented on a user interface of the at least one remote electronic device.

At 709, the prompt of 708 provides additional details about the past fraudulent activity. At 710, the prompt of 708 prompt provides a user actuation target allowing the electronic financial transaction to be terminated.

At 711, an electronic device comprises a communication device and one or more processors operable with the communication device. At 711, the communication device receives a financial transaction initiation communication from at least one remote electronic device comprising an electronic device identifier from which a financial transaction initiation request was received by the at least one remote electronic device.

At 711, the one or more processors determine whether the electronic device identifier is associated with an account identifier of an account used for fraud. At 711, when the electronic device identifier is associated with the account identifier of an account used for fraud, the one or more processors cause the communication device to present a prompt on the at least one remote electronic device warning of fraudulent activity. At 712, the prompt of 711 includes a user actuation target that, when actuated, terminates a financial transaction associated with the financial transaction initiation communication.

At 713, the electronic device of 711 further comprises a memory operable with the one or more processors. At 713, the memory stores a functional database of device identifiers associated with fraudulent activity.

At 714, the device identifiers associated with the fraudulent activity of 713 are verified by a third-party source. At 715, the device identifiers of 713 associated with the fraudulent activity are determined by a number of electronic communications reporting the device identifiers are associated with the fraudulent activity exceeds a predefined threshold. At 716 the device identifiers of 713 associated with the fraudulent activity are determined when the device identifiers are associated with falsified account or personal identification numbers.

At 717, a method comprises constructing, by one or more processors of an electronic device, a functional database compiling at least a first set of electronic device identifiers associated with falsified account or personal identification numbers, a second set of electronic device identifiers having associated therewith reports of fraudulent activity exceeding a predefined report threshold, and a third set of electronic device identifiers verified as being associated with fraud by a third party.

At 717, the method comprises receiving, with a communication device of the electronic device, a financial transaction initiation communication from at least one remote electronic device in communication with the communication device. At 717, the financial transaction initiation communication comprising an electronic device identifier from which a financial transaction initiation request was received by the at least one remote electronic device.

At 717, the method comprises querying, by the one or more processors in response to the financial transaction initiation communication, the functional database to determine whether the electronic device identifier is found in the first set of electronic device identifiers, the second set of electronic device identifiers, or the third set of electronic device identifiers. At 717, when the electronic device identifier is found in the first set of electronic device identifiers, the second set of electronic device identifiers, or the third set of electronic device identifiers, the method comprises causing, by the one or more processors, the communication device to present a prompt on the at least one remote electronic device warning of fraudulent activity.

At 718, the prompt of 717 identifies whether the electronic device identifier is found in the first set of electronic device identifiers, the second set of electronic device identifiers, or the third set of electronic device identifiers. At 719, the one or more processors of 717 cause presentation of the prompt before a financial transaction associated with the financial transaction initiation communication is completed.

At 720, the prompt of 719 comprises a user actuation target allowing the financial transaction to be terminated. At 720, the method of 719 further comprises, in response to actuation of the user actuation target, causing, by the one or more processors, the financial transaction to be terminated.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method, comprising:
detecting, with a communication device of an electronic device in communication with at least one remote electronic device, initiation of an electronic financial transaction across a network to an account having an account identifier;
querying, by one or more processors of the electronic device in response to the detecting, the account identifier to determine if the account is associated with fraudulent activity; and
if the account is associated with the fraudulent activity, causing, by the one or more processors, the communication device to transmit a fraud warning to the remote electronic device prior to the electronic financial transaction being completed.

2. The method of claim 1, wherein the initiation of the electronic financial transaction occurs in response to an electronic communication received by the at least one remote electronic device from at least one other remote electronic device having an electronic device identifier.

3. The method of claim 2, wherein the querying comprises utilizing a functional database to determine whether the electronic device identifier has been associated with past fraudulent activity.

4. The method of claim 3, further comprising determining that the electronic device identifier has been associated with the past fraudulent activity when a plurality of remote electronic devices in communication with the electronic device having a quantity exceeding a predefined threshold has transmitted electronic communications to the communication device indicating that the electronic device identifier is suspected of being used fraudulently.

5. The method of claim 3, further comprising determining that the electronic device identifier has been associated with the past fraudulent activity when a third-party server complex in electronic communication with the communication device confirms that the electronic device identifier has been used fraudulently.

6. The method of claim 5 wherein the determining that the electronic device identifier has been associated with the past fraudulent activity occurs only when the third-party server is a government operated server.

7. The method of claim 3, further comprising determining that the electronic device identifier has been associated with the fraudulent activity when the electronic device identifier is associated with a falsified account number or personal identification number.

8. The method of claim 3, wherein the fraud warning comprises a prompt presented on a user interface of the at least one remote electronic device.

9. The method of claim 8, wherein the prompt provides additional details about the past fraudulent activity.

10. The method of claim 8, wherein the prompt provides a user actuation target allowing the electronic financial transaction to be terminated.

11. An electronic device, comprising:
a communication device; and
one or more processors operable with the communication device;
wherein when the communication device receives a financial transaction initiation communication from at least one remote electronic device comprising an electronic device identifier from which a financial transaction initiation request was received by the at least one remote electronic device, the one or more processors determine whether the electronic device identifier is associated with an account identifier of an account used for fraud; and
when the electronic device identifier is associated with the account identifier of an account used for fraud, the one or more processors cause the communication device to present a prompt on the at least one remote electronic device warning of fraudulent activity.

12. The electronic device of claim 11, wherein the prompt includes a user actuation target that, when actuated, terminates a financial transaction associated with the financial transaction initiation communication.

13. The electronic device of claim 11, further comprising a memory operable with the one or more processors, the memory storing a functional database of device identifiers associated with fraudulent activity.

14. The electronic device of claim 13, wherein the device identifiers associated with the fraudulent activity are verified by a third-party source.

15. The electronic device of claim 13, wherein the device identifiers associated with the fraudulent activity are determined by a number of electronic communications reporting the device identifiers are associated with the fraudulent activity exceeds a predefined threshold.

16. The electronic device of claim 13, wherein the device identifiers associated with the fraudulent activity are determined when the device identifiers are associated with falsified account or personal identification numbers.

17. A method, comprising:
constructing, by one or more processors of an electronic device, a functional database compiling at least:
a first set of electronic device identifiers associated with falsified account or personal identification numbers;
a second set of electronic device identifiers having associated therewith reports of fraudulent activity exceeding a predefined report threshold; and
a third set of electronic device identifiers verified as being associated with fraud by a third party;
receiving, with a communication device of the electronic device, a financial transaction initiation communication from at least one remote electronic device in communication with the communication device, the financial transaction initiation communication comprising an electronic device identifier from which a financial transaction initiation request was received by the at least one remote electronic device;
querying, by the one or more processors in response to the financial transaction initiation communication, the functional database to determine whether the electronic device identifier is found in the first set of electronic device identifiers, the second set of electronic device identifiers, or the third set of electronic device identifiers; and
when the electronic device identifier is found in the first set of electronic device identifiers, the second set of electronic device identifiers, or the third set of electronic device identifiers, causing, by the one or more processors, the communication device to present a prompt on the at least one remote electronic device warning of fraudulent activity.

18. The method of claim 17, wherein the prompt identifies whether the electronic device identifier is found in the first set of electronic device identifiers, the second set of electronic device identifiers, or the third set of electronic device identifiers.

19. The method of claim 17, wherein the one or more processors cause presentation of the prompt before a financial transaction associated with the financial transaction initiation communication is completed.

20. The method of claim 19, wherein the prompt comprises a user actuation target allowing the financial transaction to be terminated, further comprising, in response to actuation of the user actuation target, causing, by the one or more processors, the financial transaction to be terminated.
